(19) United States
(12) Patent Application Publication
(10) Pub. No.: US 2015/0324767 A1
(43) Pub. Date: Nov. 12, 2015

(54) SYSTEM AND METHOD FOR RECOVERING REFUNDABLE TAXES

(71) Applicant: MasterCard International Incorporated, Purchase, NY (US)

(72) Inventors: Julie WALSH, Dublin (IE); Jean HIGGINS, Dublin (IE); Susanne MANNING, Dublin (IE); Elaine KEATING, Co. Wicklow (IE); Maximino ARCEO, Dublin (IE); Kosta KRAUTH, Purchase, NY (US); Robert CAMPION, Co. Meath (IE); Ciara HICKEY, St. Louis, MO (US)

(73) Assignee: MasterCard International Incorporated, Purchase, NY (US)

(21) Appl. No.: 14/708,766

(22) Filed: May 11, 2015

(30) Foreign Application Priority Data
May 9, 2014 (GB) 1408211.9

(51) Int. Cl. G06Q 20/10; G06Q 20/40

(52) U.S. Cl. CPC G06Q 20/10; G06Q 20/40

(57) ABSTRACT

A method for processing a transaction relating to a purchase and refunding a tax paid on the purchase. The method comprises receiving, over a network from a merchant apparatus, payment transaction data relating to a payment transaction associated with an electronic payment card; analyzing the payment transaction data to determine whether the payment transaction is eligible for a tax refund; determining a tax refund value corresponding to the payment transaction; determining that the payment transaction is authorised for a tax refund, and coordinating with at least an issuer associated with the electronic payment card in order to credit an account associated with the electronic payment card with the tax refund value. The invention is also expressed as a computing platform configured to perform the method steps previously described, and also to a system.

### TECHNICAL FIELD

The invention relates in general to electronic transactions carried out within the context of a financial authorization, clearing and settlement system. More specifically, the invention relates to a process for handling the recovery of refundable taxes that have been levied during such electronic transactions for the payment of goods and services.

### BACKGROUND

A feature that is common to the retail industry world-wide is the imposition of a sales tax or value added tax (known as VAT) to the purchases of various goods and services. Such taxes are applied for a variety of reasons such as to discourage or promote spending on certain goods categories, and serve as a significant revenue generator for a respective government. The UK, for example, imposes a ‘value added tax’ (VAT) of 20% on many categories of goods and services that are purchased. Typically such taxes will be variable in order to achieve certain economic objectives.

In some countries these taxes may be refundable to non-resident visitors under certain conditions. Staying with the UK by way of example, the ‘VAT Retail Export Scheme’ permits non-EU residents visiting the UK to recover VAT on goods they buy for personal export outside the EU. The Retail Export Scheme thus contributes to the UK economy by encouraging overseas visitors to buy goods when they visit the UK since the effective cost of those goods is reduced. The EU-wide scheme ensures that goods are taxed only where they are used and prevents ‘double taxation’, which could otherwise occur if goods were taxed in the EU when they are purchased and again in the visitor's home country when imported.

Currently, the process of obtaining a VAT refund on purchases is largely paper-based. In a typical process, when an overseas visitor visits a shop or ‘merchant’ in the UK and wishes to obtain a refund of the VAT levied on the transaction, the retailer and the customer complete a tax recovery document (e.g. HMRC official form VAT407) with details of the transaction. A prerequisite of this, however, is that the retailer participates on the VAT Retail Export Scheme, usually identified by the ‘Tax Free Shopping’ sign.

When leaving the EU, the visitor is required to present the tax recovery document and the goods at UK customs at their point of departure from the EU for inspection and validation by a customs official. Once the tax recovery document has been approved by customs, the tax recovery document may be sent to the retailer who will then refund the visitor and ‘zero-rate’ the transaction in the business accounts. Some retailers pay the refund directly, but others may choose to operate through a third party refund company. Alternatively some retailers may have arrangements with a refund booth at UK departure ports, and perhaps other locations such as shopping malls, which provide visitors with the facility to obtain refunds before leaving the country. Note that other EU countries have similar Retail Export Schemes in place and similar processes exist for many non-EU countries.

As will be appreciated by the above discussion, the process is by-and-large a manual one and requires engagement between retailers and customers to fill in documentation which reduces the effectiveness of the process, reduces take-up and, ultimately, may discourage overseas visitors from spending on big-ticket items in the home country. Thus, there is a need to increase the efficiency of the process.

One proposal is described in U.S. Pat. No. 6,546,373 (B1) in which purchases subject to VAT (or sales tax) made by a traveller are recorded on an electronic transaction card that is loaded with a dedicated software application that is able to record the relevant purchases. During the traveller's visit to a foreign country, the electronic transaction card records the purchases made and accumulates the refundable tax amount. When the traveller leaves the country, the electronic transaction card may be inserted into a suitable terminal which reads the purchase information and manages a tax refund application process including communicating with a suitable taxing authority and tax recover application supplier if appropriate. The traveller may be issued with a tax refund for eligible purchases there and then at the terminal.

It is against this background that the invention has been devised.

### STATEMENTS OF INVENTION

In one aspect the invention provides a method for processing a transaction relating to a purchase and refunding a tax paid on the purchase. The method comprises:
receiving, over a network from a merchant apparatus, payment transaction data relating to a payment transaction associated with an electronic payment card,
analyzing the payment transaction data to determine whether the payment transaction is eligible for a tax refund,
determining a tax refund value corresponding to the payment transaction,
determining that the payment transaction is authorised for a tax refund, and
coordinating with at least an issuer associated with the electronic payment card in order to credit an account associated with the electronic payment card with the tax refund value.

The invention may also be expressed as, and therefore also embraces, a system for processing a payment transaction relating to a purchase, and refunding a tax paid on the purchase, the system comprising:
a merchant apparatus for generating a payment transaction relating to a purchase and to transmit the transaction over a network,
a transaction processor configured to receive payment transaction data relating to the payment transaction transmitted to it over the network, wherein the transaction processor is configured to:
   analyze the payment transaction data to determine whether the payment transaction is eligible for a tax refund,
   determine a tax refund value corresponding to the payment transaction,
   determine that the payment transaction is authorised for tax refund, and
   coordinate with at least an issuer associated with the electronic payment card in order to credit an account associated with the electronic payment card with the tax refund value.

Still further, the invention may also be expressed as a computing platform configured to process payment transactions relating to electronic payment cards conducted over a network, wherein the computing platform is further configured to:
receive payment transaction data relating to a payment transaction associated with an electronic payment card,
analyze the payment transaction data to determine whether the payment transaction is eligible for a tax refund,
determine a tax refund value corresponding to the payment transaction,
determine that the payment transaction is authorised for a tax refund, and
coordinate with at least an issuer associated with the electronic payment card in order to credit an account associated with the electronic payment card with the tax refund value.

Advantageously, the invention provides a scheme, be it expressed as a process, system or platform, for harvesting data from payment transactions and providing the cardholder relating to the transaction with the facility to obtain a refund of the tax that is paid on the purchase. Known systems for claiming tax refunds are largely paper-based and require a significant level of involvement from both the merchant and from the user/cardholder at the point of sale. This administrative burden reduces the financial incentive for the cardholder to make a tax reclaim which means take up is generally poor in comparison with the level of overseas travel. The invention, however, provides a process which is largely transparent to the user by integrating an automated process within the existing organisational infrastructure and networks of the transaction processor that manages the payment transactions between merchants, acquirers and issuers.

In the illustrated embodiment, the payment transaction data is transmitted by way of one or more clearing files. Each of the clearing files may contain one or more clearing records, as typically would be transmitted by a merchant during the clearing process in a financial transaction network. In turn, each of the clearing records corresponds to a payment transaction. So, harvesting the payment transaction data through the established clearing record channel provides a convenient and efficient way of extracting the data necessary for determining a suitable refund that is due to the cardholder associated with the payment transaction since it harnesses established data channels that are, however, used for a different purpose in the financial transaction environment.

In order to identify transactions that should be eligible for a tax refund, a database may be built so that data relating to a cardholder corresponding to the electronic payment card may be stored for identity verification. The stakeholder database may therefore act as a filter to identify payment transactions that are eligible to take part in the VAT refund process by cross referencing cardholder data relating to the transaction with cardholder data stored in the database. In this way, it can be determined that the payment transaction is ‘cross-border’ and so is, in principle, eligible for a tax refund. In one embodiment, the analysis of the payment transaction data to verify that the transaction is a cross-border transaction includes comparing the country in which the merchant is based with the country in which the issuer is based. Conveniently, this may involve comparing a merchant ID data field and a Bank Identification Number (BIN) data field in the payment transaction data.

The analysis of the payment transaction data may further include: firstly, verifying that the amount of the payment transaction meets a predetermined minimum amount threshold, a predetermined maximum amount threshold, or a minimum and maximum threshold—this ensures that the transaction meets with the spend limits that may be imposed within a given territory; and/or secondly, verifying that a merchant ID data field corresponding to the merchant apparatus is a registered participant. Thus, it is ensured that the merchant is validly registered for taking part in the VAT refund regime offered by the relevant government authority of the country concerned.

In order to determine the tax refund value, the transaction processor may be configured to calculate a tax amount based on a transaction amount field included in the payment transaction data. In doing so, the transaction processor may be configured to verify a tax rate applicable to the payment transaction, the tax rate being transmitted with the payment transaction data or, alternatively, obtained from internal storage means. Alternatively, the transaction processor may be configured to apply a refund factor to a salves value item of the transaction data. The refund factor may be selected based on the sales value of the transaction, so a higher refund factor may apply to high value sales, and a lower refund factor may apply to lower value sales. Preferably, the refund factor is selected from a set of refund factors, each of which corresponds to a range of sales values. Calculating the tax refund in this way may provide a more efficient means to calculate the refund due to the cardholder, and also is more easily understood by the cardholder when viewing literature regarding the tax refunds that they can expect when using the scheme.

In order to obtain authorization for the tax refund, in the illustrated embodiment, the transaction process may be configured to receive authorization from a tax refund agent. Tax refund agents are entities that have established businesses providing tax refund to consumers and are therefore efficient at processing stamped customs forms from cardholders and obtaining funds from the relevant tax authorities.

In order to obtain the end-authorization from the tax refund agent, prior to this the transaction process may be configured to liaise with the cardholder by generating a transaction record from the payment transaction data and communicating the same to a computing device associated with the electronic payment card for display to the cardholder. In response, the transaction processor may receive a selection of one or more transaction records from the computing device for which a refund is requested. The computing platform therefore provides the facility to interact with the cardholder to, firstly, present their spending record in a visual manner and, secondly, to seek a selection of those transactions that the user wishes to obtain a tax refund. Once the selection has been made, the computing platform may be arranged to collate the selection, generate a tax refund file including the selected transaction records and communicate this to the tax refund agent so that authorization can be given.

In order to credit the cardholder with the refund, the computing platform may be arranged to trigger a payment to the issuer associated with the electronic payment card through an intermediary account. This account may be credited directly or indirectly by a tax authority.

Within the scope of this application it is intended that the various aspects, embodiments, examples and alternatively set out in the preceding paragraphs, in the claims and/or, in the following description and drawings, and in particular the individual features thereof, may be taken independently or in any combination. Features described in connection with one embodiment are applicable to all embodiments unless expressly stated or unless such features are incompatible.

### BRIEF DESCRIPTION OF THE DRAWINGS

In order that the invention may be more readily understood, reference will now be made, by way of example, to the accompanying drawings in which:

FIG. 1 is a system diagram illustrating the entities involved in a system and process according to an embodiment of the invention;

FIG. 2 is a schematic diagram of a computing device used in the system of FIG. 1;

FIG. 3 is a flowchart illustrating a process as implemented by a VAT refund manager;

FIG. 4 is a flowchart illustrating a further process as implemented by the VAT refund manager;

FIG. 5 is a flowchart illustrating a process through which a cardholder may obtain a refund of tax paid on a purchase;

FIG. 6 is a process that is an extension of the process in FIG. 2; and

FIG. 7 is a diagrammatic view of a clearing file and associated clearing record(s).

### DETAILED DESCRIPTION OF THE INVENTION

The process will be described in the context of VAT regime currently operating in the UK, although the skilled person will appreciated that the invention is also applicable to other ‘sales tax’ regimes in other countries. Hereinafter, references to terms such as VAT′, ‘tax’ and the like shall be taken to be a sales tax imposed on goods and services unless otherwise stated, and generally herein the term ‘VAT’ will be used as encompassing all such regimes but both terms should be considered synonymous.

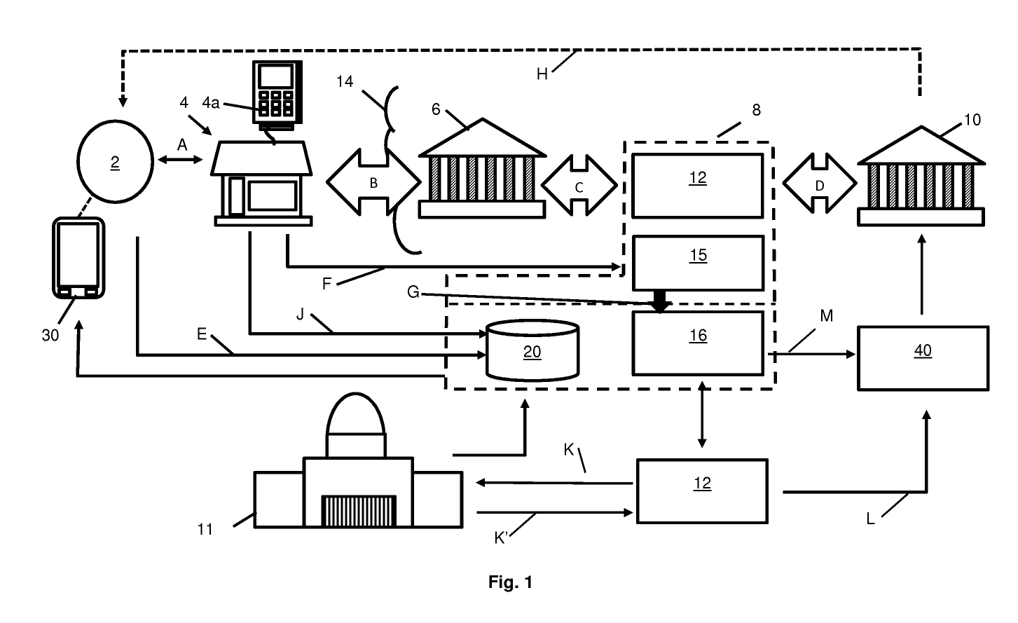

FIG. 1 illustrates a block diagram of a system supporting a financial transaction between a cardholder 2 and a merchant 4. The system also involves a merchant acquirer bank, or more simply ‘acquirer’ 6, an issuing bank, or more simply ‘issuer’ 10, and an organisation 8 that facilities the routing/processing of financial transactions between acquirers 6 and issuers 10. In the UK context, the service provided by the organisation 8 may be provided by a payment network infrastructure brand such as Visa or MasterCard, although the skilled person will be aware of other such service organisations. Hereinafter, the organisation 8 will be referred to as the ‘transaction processor’.

FIG. 1 also illustrates the participating entities in a process by which the cardholder 2 may be recompensed for the tax (in this case, VAT) paid on the amount of the transaction. In overview, these participating entities are the transaction processor 8, a tax authority 11, which in the UK context is represented by HMRC (Her Majesty's Revenue and Customs), and a VAT refund agent 12.

The service provided by the VAT refund agent 12 is known in the art. Such a service makes the VAT refund process easier for users since they allow the user to obtain an immediate refund of the VAT paid on their purchase. Examples of companies that provide such a service are Global Blue and Premier Tax Free. Without these services a user would be required to liaise directly with the tax authority 11 which is usually a more complex and slower process. Since such agencies are known to the skilled person, it will not be described in further detail here.

At this point, it should be appreciated that the terms ‘issuer’, ‘acquirer’, ‘merchant’ ‘transaction processor’, ‘tax authority’, ‘tax reclaim agent’ and the like are intended to mean computer implemented systems that represent those establishments and that are able to communicate data and instructions between one other, as appropriate, using established protocols.

The financial transaction is a payment transaction for the purchase of goods/services in which the merchant 4 communicates with a financial transaction network 14 for authorization for the payment prior to later completion of the transaction by way of a clearance and settlement process, as would be known to the skilled person. Since the tax refund process relates to the claiming back of goods purchased in the UK, it is envisaged that the financial transaction will relate to transactions originating in physical ‘bricks and mortar’ establishments to minimise fraud opportunities as opposed to online ‘cardholder not present’ payments which may be originated at locations outside of the UK. It should be noted, however, that ‘cardholder not present’ type payment transactions that may be conducted using a digital wallet may also be used. Here, the cardholder is an overseas resident, normally resident in a country that would make the traveller eligible to reclaim VAT paid on goods purchased in the UK/EU.

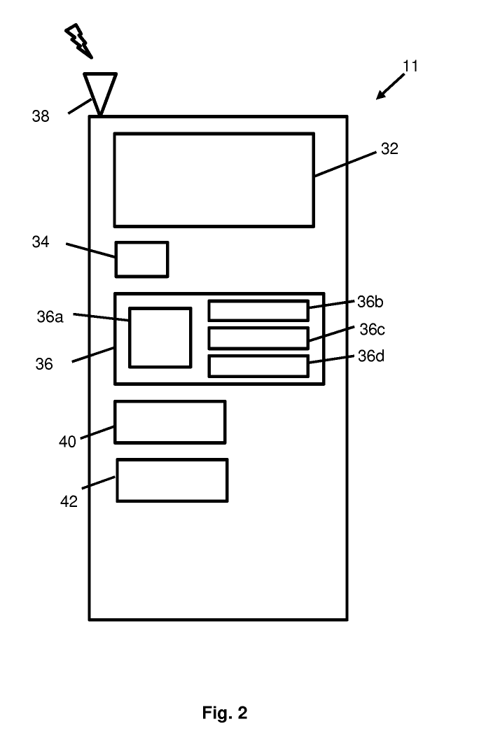

The cardholder is shown here as associated with a computing device 30. The computing device 30 may be any suitable computing device but preferably a mobile computing device such as a mobile phone or tablet computer by way of non-limiting example. For completeness, the computing device 30 is shown in more detail, but still schematically, in FIG. 2, in which the computing device 30 comprises in overview a display means 32 in the form of screen, a user interface module 34, a processing module 36, an antenna 38, a communications interface module (CIM) 40 and a wireless transceiver module 42.

The display screen 32 and the user interface module 34 are linked so that the user can input data into the device 30 via the display screen, as is known. Alternatively or in addition a key-based data entry system may be provided.

The antenna 38 is controlled by the CIM 40 and so provides a means for the device 30 to communicate with radio telecommunications networks in a known manner.

The processing module 36 provides the processing functionality for the device 30 and, as shown here, includes a central processing unit 36a and a plurality of memory modules 36b-d, including a first memory module 36b being preferably non-volatile for storing suitable BIOS and boot programs and the like, a second memory module 36c, preferably being volatile memory, for storing permanent and temporary software applications or ‘apps’ for execution by the processing module 36, and a third memory module, also preferably being volatile memory, for storing data generated by the software applications executed on the device.

The wireless transceiver module 42 is provides the device 30 with the facility to communicate wirelessly with other devices or networks under a variety of communications protocols, for example as governed under the IEEE 802.11 standards as would be known to the skilled person

Returning to FIG. 1, although the authorization, clearing and settlement stages of a complete payment transaction would be familiar to the person skilled in the art, a brief overview will be provided here for completeness.

### Authorization

On initiation of a transaction, the merchant constructs an authorization request including payment information and sends the authorization request to its financial institution, the acquirer, for authentication. The acquirer authenticates the identity of the customer/cardholder and forwards the authorization request message to the transaction processor (for example MasterCard or Visa, depending on the payment card branding) for account validation and routing. At this point, the transaction processor may also perform additional security checks such as risk profiling and fraudulent activity detection. From there, the transaction processor routes the authorization request message to the issuer, for verification. Once the issuer verifies the availability of funds for the amount of the transaction, and ring fences them, it sends the verification back to the transaction processor. In turn, the transaction processor routes the verification to the acquirer who, in turn, notifies the merchant that the purchase has been approved.

### Clearing

Following completion of the transaction between the cardholder and the merchant, the transaction undergoes ‘clearing’. Typically within a day of authorization, the merchant batch-transmits all of their sales transactions associated with the organisation represented by the transaction processor to the acquirer. The acquirer batches and sends the payment information to the transaction processor which then validates the accuracy of the transaction information submitted by the acquirer in order to reconcile funds between issuers and acquirers. This reconciliation process balances funds between payment parties on a regular basis.

### Settlement

Typically within two days of authorization, and after transactions have been cleared, the transaction processor calculates the debited and credited amounts between issuers and acquirers, also termed the ‘net settlement position’. During this process, the issuer is informed of the funds to be debited from cardholder accounts to settle transactions and the acquirer is informed of the funds to be credited to merchant accounts net of fees levied by the transaction processor.

### Cardholder Enrollment Process

The above sections explain in overview the process by which a financial transaction is propagated up and down a communication chain between a merchant and an issuer. A transaction will now be described in more detail together with an associated process/scheme/method by which VAT paid on the transaction may be refunded to the cardholder.

At this point, it should be noted that the transaction processor 8 comprises a plurality of functional units in addition to the authorization module 9, each unit performing a respective role in the tax refund process. A first of these functional units is a clearing module 13 whose role is to implement the clearing processes for the transaction processor 8, as will be described.

The second of these functional units is VAT refund manager 15 comprising a VAT refund module 16 and a VAT database 20. The transaction processor therefore provides a computing platform for processing payment transactions relating to electronic payment cards and also for identifying those payment transactions that may be eligible for VAT refunds, and for processing the VAT refunds to the cardholder.

It will be appreciated that these functional modules are shown separately in FIG. 1 but this is not intended to be limiting. For example, the functionality carried out by the modules may be configured in any suitable way in single computing device, or indeed multiple computing devices, located at the transaction processor 8 or the functionality may be cloud based.

Prior to the commencement of a financial transaction from which the VAT may be refunded, cardholder 2 is required to enrol or register with the transaction processor 8. Specifically, cardholder details are input into a VAT database 20, thereby setting up a cardholder account. Here, the VAT database 20 is shown as part of the established business infrastructure of the transaction processor 8 although, alternatively, it is envisaged that the database 20 may be a cloud-hosted system that may be provided by a different, but trusted, organisation.

In the registration process, the cardholder 2 provides a variety of data items. For instance, the cardholder may provide such data items as: name, address, country of residence, citizenship, contact details, and details of the card (for example the primary account number or ‘PAN’) which they wish to be registered on the scheme.

Other data items would be apparent to the skilled person. All such data items are combined into a suitable cardholder account in the database 20 that is accessible by the transaction processor 8. The enrollment process is in essence an administrative exercise and, as such, may be a paper-based process in which the cardholder 2 completes a suitable registration form and sends this to the transaction processor 8 by mail for processing. Alternatively, and more efficiently, the registration process may be carried out in online environment, for example as could be provided by a suitable software application or ‘app’ implemented on the cardholder's computing device 30. The data provided during the registration process may be augmented at a later date as required; for instance the cardholder may supply travel details such as inbound and outbound flight information which will provide a means of verifying the travel status of the cardholder.

The registration process therefore harvests data from the cardholder 2 so that the parties participating in the tax refund scheme may pre-vet the cardholder thereby ensuring that they are authorised to participate in the tax refund scheme. Thus, the tax authority 11 can impose certain data requirements that must be satisfied for cardholders to participate, and the transaction processor 8 is therefore able to implement risk management processes to evaluate cardholders and ensure that they have a suitable low risk profile. Here, the data flow for the cardholder relating to the registration process is indicated by the reference ‘E’.

### Transaction Process

Returning to the transaction process, it begins by the initiation of a financial transaction by the cardholder 2 communicating with the merchant 4 as indicated by arrow ‘A’ in order to pay for goods and services and, more specifically, to seek authorization for the payment. This may be by way of the cardholder 2 processing their electronic payment card through a point of sale (POS) apparatus 4a associated with the merchant via a chip and pin card reader or by interaction with a digital wallet carried on the mobile device 30 which acts as a proxy for a physical card. Accordingly, the transaction may be conducted under the EMV (Europay Mastercard Visa), ISO/IEC 7816, and ISO/IEC 14443 standards, as are known in the art, although other transaction protocols also apply.

The merchant 4 then completes the necessary authentication checks and constructs or ‘builds’ a payment transaction. The payment transaction is communicated in the form of an ‘authorization request message’ to the acquirer 6 via the network 14, as indicated by arrow ‘B’, in order to obtain an authorization for the payment that the cardholder 2 wishes to make. The network may be the internet or another suitable telecommunications network.

In response to the contact from the merchant 4, the acquirer 4 then communicates the authorization request message to the authorization module 9 of the transaction processor 8, as illustrated by arrow ‘C’. The authorization request message contains suitable data fields appropriate to secure an authorization or denial of the transaction from the issue, for example as specified in ISO8583, as would be known by the skilled person. Such data fields may include card data such as the primary account number (PAN) of the card, expiry date and verification details, transaction date and time data, merchant information including the name, ID code and merchant category code (MCC) or multiple MCCs if applicable, transaction value data, currency type, and authorization status data.

At this point the authorization module 9 communicates (arrow D) with the issuer 10 of the cardholder's electronic payment card after it has carried out appropriate validation and security checks. The issuer 10 then carries out necessary credit worthiness checks to ensure that the account balance of the cardholder is sufficient to cover the payment amount and fraudulent activity checks and communicates a response back to the authorization module 9 (arrow ‘D’) either granting authorization for the transaction or denying authorization. It should be noted that since the process relates to the manner in which a VAT-refundable goods are purchased by the cardholder 2 who is resident overseas, it will be appreciated that the issuer 10 may not be resident in the same country as the merchant. More likely, in fact, that the issuer 10 is based in the same country as the cardholder 2 has residency, although this is not essential.

The transaction will also include the authorization/denial from the issuer 10 and the transaction processor 8 communicates back to the acquirer 6 (arrow ‘C’). Having received the transaction including authorization/denial from the issuer 10 the acquirer 6 then communicates the transaction back to the merchant 4 (arrow ‘β’). At this point, the merchant 4 has received the authorization for the original transaction and so the merchant 4 communicates the authorization to the user/cardholder 2, as illustrated by arrow ‘A’, thereby completing the transaction.

As discussed above, an overseas user/cardholder 2, particularly a non-EU resident, may purchase goods for which they wish to claim back the VAT paid on the goods, which is currently 20% in the UK. The process of the invention provides a means for the user to make such a tax reclaim by way of an electronic system which avoids the need to complete a paper-based tax refund application on the premises of the merchant 4 and provides a much more flexible and swift resolution to the application.

### Tax Refund Scheme/Process

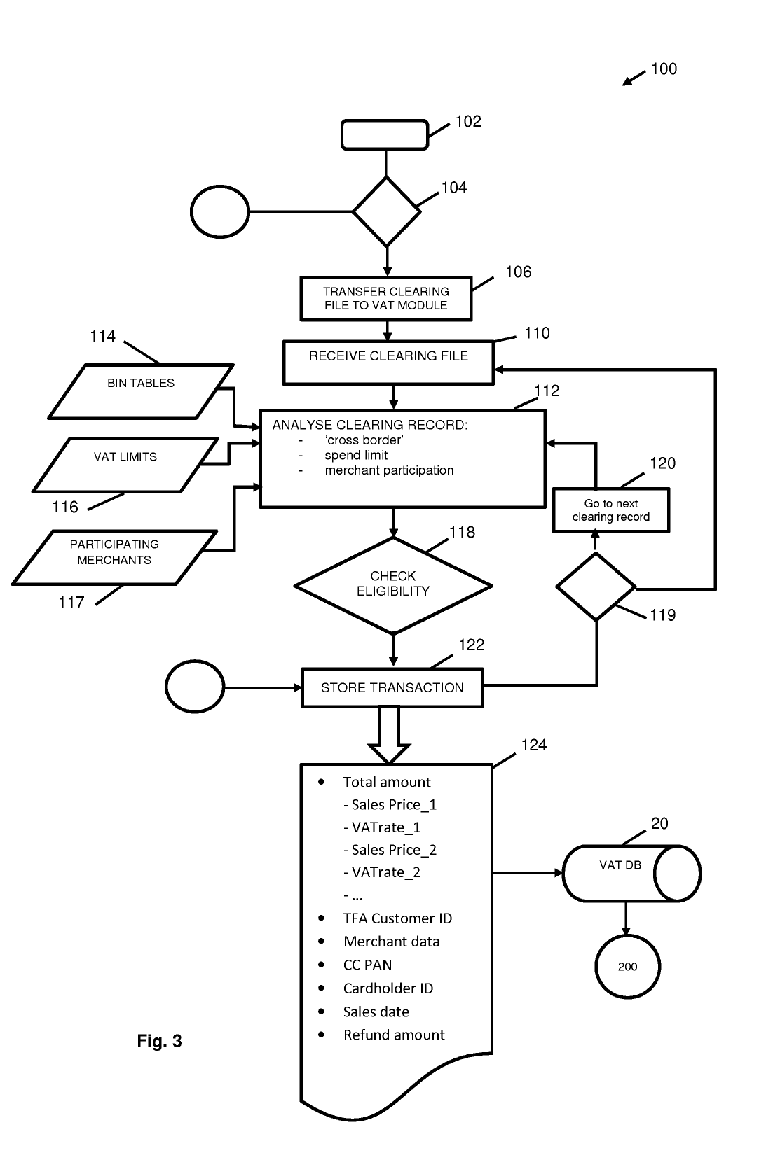

The means by which the cardholder 2 is able to obtain a refund of the VAT paid on the transaction operates in conjunction with the payment transaction described above with reference to FIG. 1 and is described below with reference to FIGS. 3 to 7.

The process begins with a data harvesting and analysis phase.

### Data Harvesting

The data harvesting and analysis phase is initiated by the clearing module 13 of the transaction processor 8 as it conducts clearing of the transactions for which it is responsible. The data exchange during the clearing process provides the verification for the funds debited from issuers and credited to acquirers and enables i) the acquirers to credit merchants accounts and ii) the issuers to match authorization records to the clearing data and to debit cardholder accounts appropriately. Clearing is conducted in accordance with whether the transaction is conducted under a dual-message protocol or a single message protocol, as would be known to the person skilled in the art.

In a dual message transaction, the merchant 4 first sends the authorization request message to the acquirer but then, at a later time, batch submits all of its stored transactions to the transaction processor in an electronic clearing file to a clearing module 13 of the transaction processor. In this scenario, therefore, the clearing file contains payment transaction data in the form of ‘clearing records’, and the data transfer is shown in FIG. 1 by arrow ‘F’, which may be a transmission over a dedicated communications line or a transmission over a suitable network, e.g. network 14.

In a single message transaction, as applies to so-called chip and pin transactions generally found in territories outside of the Europe, authorization and clearing are performed in one dispatch, that is a clearing file is transmitted at a similar point in time to the authorization request message. In this case, therefore, the clearing file transmitted to the clearing module 13 includes a single clearing record since it relates to a single transaction as opposite to a clearing file sent during a batch transmit operation under the dual message protocol.

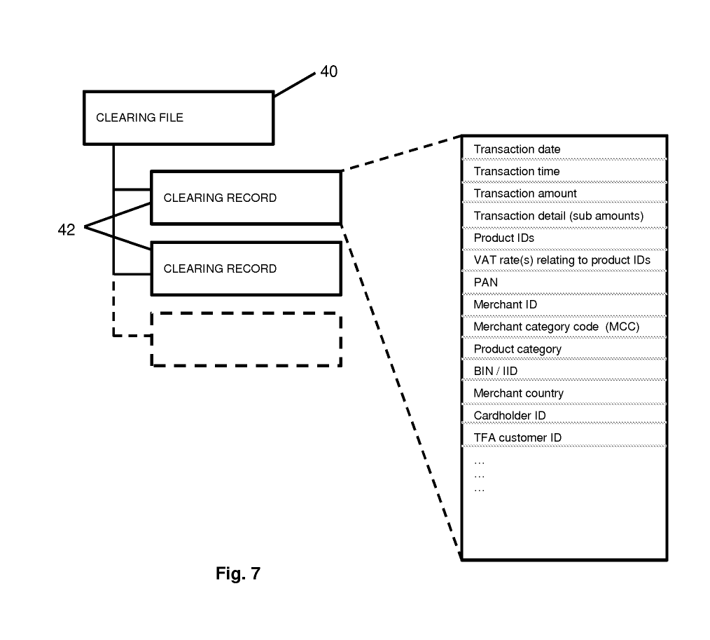

A schematic example of a clearing file 40 is shown in FIG. 7. Here, the clearing file 40 is shown as including one or more clearing records 42 and a clearing record is shown in expanded form to the right of the Figure. The clearing record 42 includes data fields such as transaction details (date, time, amount, sub-amounts); the primary account number (PAN) of the card; merchant information including the name, ID code, country of residence and merchant category code (MCC) or multiple MCCs if applicable; Bank Identification Number data (BIN—identifies the issuer of the transaction card); cardholder ID, used to identify the cardholder in the registration process described above; customer ID, used to identify the merchant to the VAT refund agent.

The skilled person would understand that a clearing record 42 may contain further data fields than those illustrated in FIG. 7.

The data collection process beings at step 102 and diverges at step 104 depending on whether the payment transaction is conducted through the financial network managed by the transaction processor 8, in which case the process proceeds to step 106, or whether the transaction is conducted by other means, in which case the process proceeds to sub-process 300, as will be described later.

At step 106, the clearing module 13 transfers a clearing file 40 to the VAT module 16, as illustrated by the arrow ‘G’. The clearing file 40 may contain a single clearing record, as may be the case if the transaction is conducted under the single message protocol, or the clearing file may contain multiple clearing records, as would apply under a dual-message protocol. Whichever protocol applies, the clearing module 13 transfers the clearing file 40 to the VAT module 16 in addition to performing its established functions in the clearing process. It is envisaged that the clearing record 40 that is transferred to the VAT module 16 will be a copy of a clearing record that will be processed by the clearing module 13 during the clearing procedure.

At step 110, the VAT module 16 receives the clearing file 40 from the clearing module 13 and, at this point, the VAT module 16 is ready to begin the analysis of the one or more clearing records 42 received within the clearing file 40.

The objective of the clearing record analysis is to determine whether a payment transaction corresponding to a respective one of the or each clearing records is eligible to be processed for a VAT refund. This is achieved by determining whether the data items within the clearing record satisfies a set of eligibility criteria. In this embodiment these are: i) that the transaction is ‘cross border’, ii) that the transaction amount is within certain predetermined limits, and iii) that the merchant is registered with the national tax authority (e.g. HMRC) as a participant in a relevant VAT refund scheme (in the UK for example, a merchant must be registered to participate in the VAT Retail Export Scheme).

So, at step 112 the process begins analyzing the clearing file by starting with the first clearing record. The analysis step 112 uses external data stores to carry out the analysis. The first of these data stores is a ‘BIN data’ store 114 which carries a list of known Bank Identification Numbers (BINs) and the resident countries associated with each BIN. This serves to cross reference the BIN stored in the clearing record against the territory in which the bank is registered.

A second data store 116 includes information on the VAT LIMIT threshold(s) that exist in each country of interest. Some countries may implement a minimum spend threshold to make a purchase eligible for a VAT reclaim whereas some countries may alternatively, or in addition, implement a maximum spend threshold. Some countries may not implement a minimum or a maximum spend threshold.

A third data store 117 lists merchant identification numbers or ‘Merchant IDs’ and tags them as to whether that merchant participates with the VAT Refund scheme in a relevant country. The participating merchant data can be configured to list merchants in one or more countries.

In order to determine if the traction is eligible, the process first compares the merchant country data in the clearing record with the country associated with the relevant BIN. By way of further example, if the merchant country data in the clearing record is ‘UK’ and the country associated with the BIN data in the clearing record is ‘USA’ then the transaction is eligible for a VAT refund since this identifies that the cardholder is a non-resident of the UK. Conversely, if the merchant residence data is ‘UK’ and the country associated with the BIN data in the clearing record is ‘Germany’, the transaction is not eligible for a VAT refund since travellers from Germany (within the EU) are not permitted to reclaim VAT refunds.

The second eligibility check is to determine whether the transaction amount meets the minimum and maximum criteria for claiming a VAT refund as is stipulated by the tax authority 11 in the merchant country. Here, the process compares the transaction amount with the data contained in the VAT LIMITS data store 116.

The third eligibility check is to confirm that the merchant associated with the transaction is a registered participant, and this is achieved by cross referencing the ‘Merchant ID’ data in the clearing record with the merchant ID entry in the participating merchant data store 117.

Optionally, the analysis step 117 may include a further condition which would determine eligibility of the transaction for a VAT refund based on the category of product included in the clearing record. This product category code could be cross referenced against an internal data store that lists product categories and whether each of those categories is eligible for a refund of VAT. It should be noted that this condition is considered to be optional because non-eligible categories of goods are usually services and consumables, the associated merchant of which would usually not be registered for VAT refunds. So, the eligibility of the goods themselves for a VAT refund is usually filtered by the check for the participating merchant as described above.

It should be noted at this point that the analysis step 112 may be configured to implement more detailed eligibility rules if desired.

Once the analysis of the clearing record 42 has been completed at step 112, the process continues to decision step 118 which coordinates the results of the clearing record analysis and makes a final decision on eligibility.

If the decision step 118 returns a negative result, then the process flow routes to switch 119 which checks whether there are any further clearing records 40 still to be analyzed in the clearing file 40. If no clearing records remain to be analyzed, then the process returns to step 110 at which a new clearing file is received into the VAT module. A suitable queuing system may be implemented here so that incoming clearing files 40 are buffered prior to being analyzed.

If decision step 119 determines that there are more clearing records to analyze, then the process increments to the next clearing record at step 120 which is then analyzed as before at step 112.

If the eligibility check step 118 returns a positive result, the process continues to step 122 in order to store the transaction relating to the clearing record 42. Here, data is read from the clearing record 42 to generate a corresponding transaction record 124 which is then stored in VAT database 20.

The transaction record 124 is exemplified in FIG. 3 and includes one or more VAT data pairs associated with a total transaction amount. Each of the VAT data pairs relates to a product purchased in the transaction and recorded in the clearing record and so includes an amount and a VAT rate. By way of explanation, a single transaction may include the purchase of Product_1, Product_2 and Product_{—}3 and so on, each of which may have a different VAT rate applied to it, although it is more usual for a single VAT rate to apply. During the storing of the transaction record 124, the process reads VAT information from the clearing record and links the VAT rate to each product purchased in the transaction. In transaction record 124, these pairs are shown as SALE_PRICE_1, VAT_rate1; SALE_PRICE_2, VAT_rate2 and so on.

The transaction record 124 also stores further information from the clearing record such as merchant data (including items such as business name and address, country code, merchant category code (MCC), and the like), PAN, and further transaction details such as the date of the transaction and the cardholder user ID if available from the registration process, as well as other items as will become apparent.

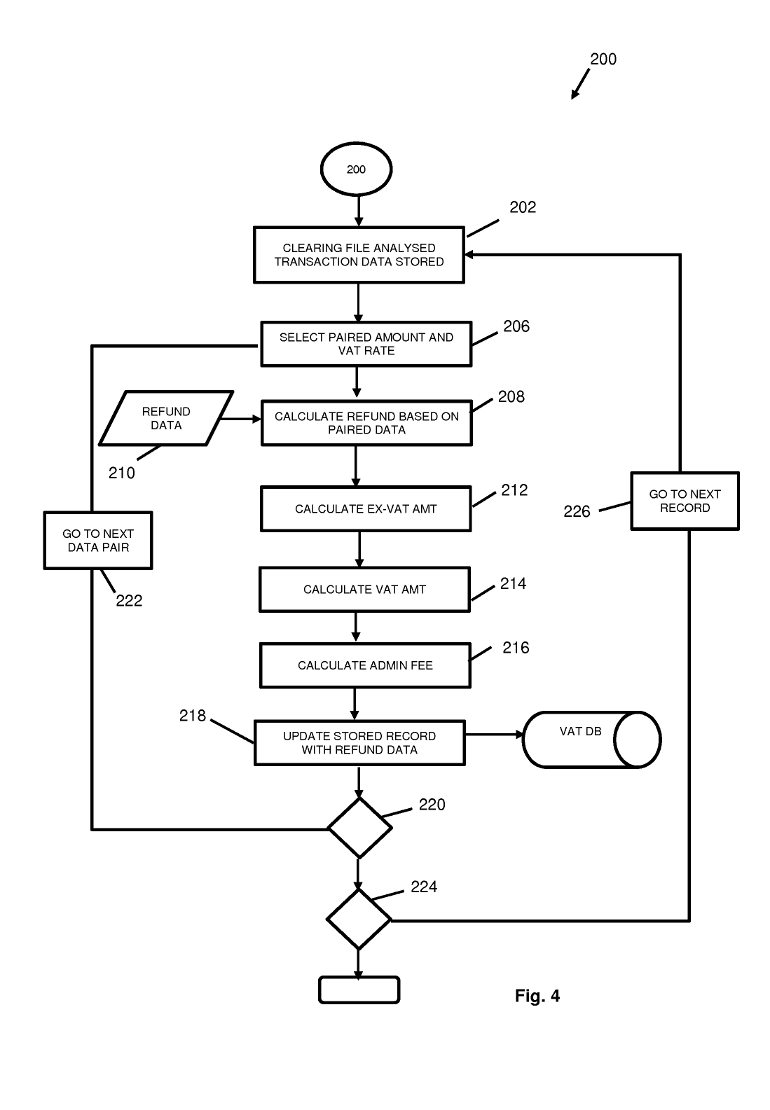

Once the clearing record 42 has been identified as eligible and stored in the VAT database 20 as a transaction record 124, the process transfers to a further process 200 during which VAT refund value data is calculated, which will now be described with reference to FIG. 4.

At step 202 the process 200 confirms that the initial analysis of the clearing file 40 carried out by process 100 has been completed and that the transaction record 124 has been stored in the VAT database 20. It will be appreciated therefore that, in this embodiment, process 200 operates concurrently with process 100. So, whilst the process 100 is analyzing the clearing files 40 transmitted to the VAT module 16 by the clearing module 13, process 200 is analyzing the transaction records 124 that are stored in the VAT database 20 by process 100.

The process 200 then proceeds through a series of steps in which it calculates the refund value that is due to the cardholder with respect to the transaction record 124. It also calculates an admin fee that will be extracted by the VAT module 16 for providing the VAT refund service to the cardholder 2.

In more detail, at step 206 the process selects a first VAT data pair (e.g. SALE_PRICE_1, VAT_rate1) in the transaction record 124 and then step 208 calculates the refund amount due to the cardholder associated with the VAT data pair. To do this, the process refers to data store 210 which provides a set of refund factors relating to value bands of the amount item of the data pair. For example, if the sale price amount is between 0 and £100, this may trigger a 10% refund, whereas if the sale price amount is between £100 and £200, this may trigger a 15% refund, although it should be noted that such figures are given for explanatory purposes only.

The process then moves on to steps 212 and 214 for calculation of the absolute VAT amount with respect to the selected VAT data pair. In step 212, an EX-VAT AMOUNT (sale price exclusive of VAT) is calculated and then, in step 214, the absolute value of VAT (VAT_AMT) is determined by subtracting the EX-VAT AMOUNT from the SALE_PRICE.

Following this, step 216 calculates the admin fee by subtracting the VAT_AMT from the refund amount determined at step 208. Once the refund amount has been calculated, the process updates the transaction record at step 218 by inserting the refund amount, the EX_VAT AMOUNT and the VAT_AMT in the appropriate data fields in the transaction record 124 as stored in the VAT database 20.

Once the transaction record 124 has been updated, the process moves on to decision point 220 which checks whether there are further VAT data pairs in the transaction record 124. If there are further VAT data pairs to analyze, then the process increments to the next VAT data pair via step 222 and starts the analysis process once again at step 206.

Once all VAT data pairs have been analyzed, the process goes to decision step 224. If there are further transaction records 124 to be analyzed that have been stored by process 100, then the process increments to the next transaction record 124 via step 226 and loops back to the start of process 200 at step 202.

It will be appreciated that this embodiment describes one way in which the VAT refund amount may be calculated. Alternatively, the refund amount may be calculated to be equal to the amount paid on the purchase less a suitable admin fee.

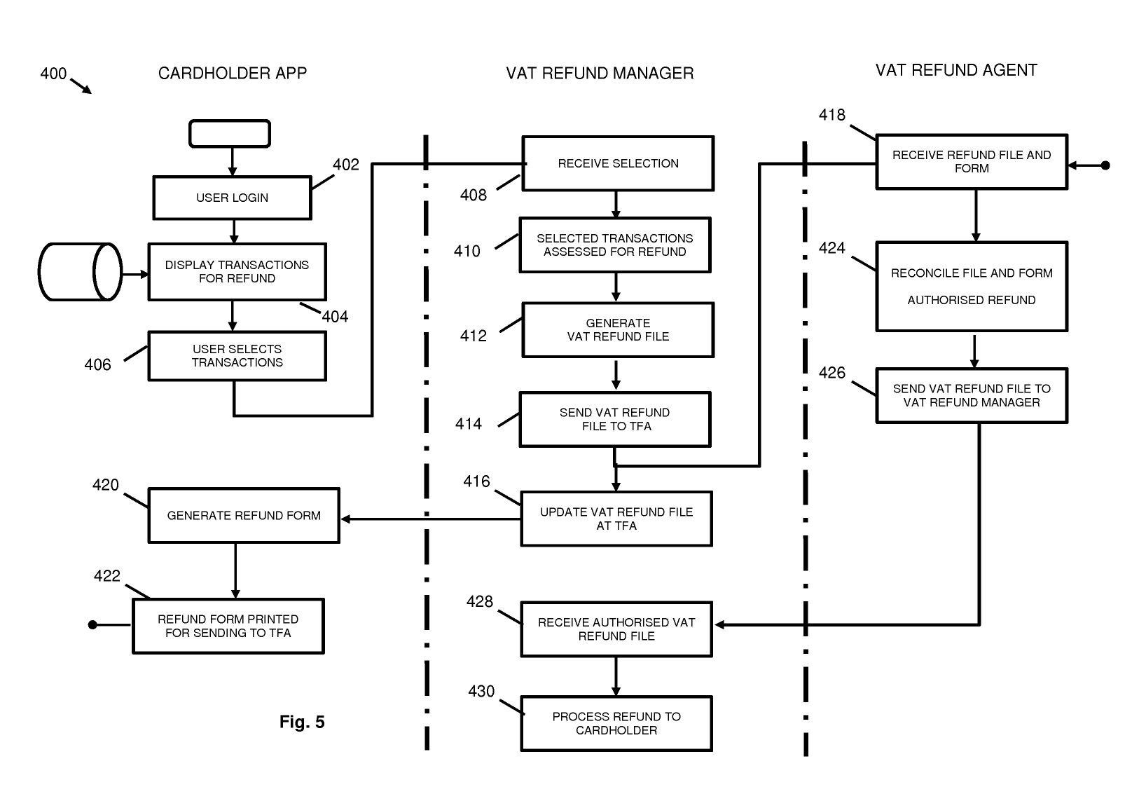

At this point, the reader will appreciate that the process 200 provides a means for determining the refunds that are due to the cardholder. The way in which the refund will be fed back to the cardholder will be described with reference to FIG. 5.

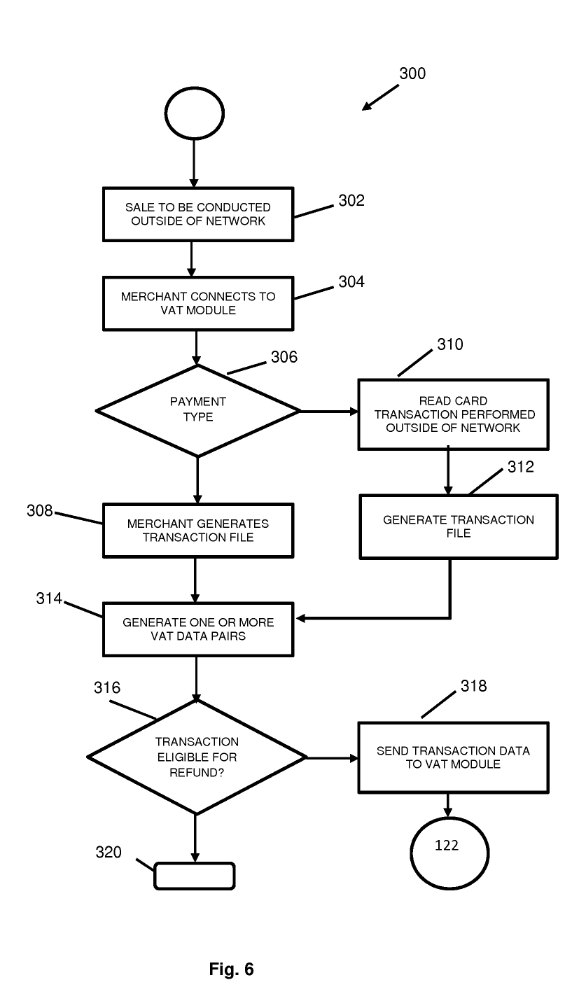

However, reference will firstly be made to a further process 300 shown in FIG. 6. The process 100 described above with reference to FIG. 3 relates to the processing of transactions that are conducted over the transaction infrastructure operated by the transaction processor 8. So, transactions relating to its own branded cards will automatically be analyzed for eligibility for a VAT refund. However, the invention also provides the facility for transactions carried out external to the transaction infrastructure provided by the transaction processor 8 to be incorporated into the VAT refund scheme. Process 300 provides an embodiment of how this may be realised.

Process 300 begins at step 302 which links to decision step 104 in process 100 as described above. Step 102 represents the initiation of a financial transaction at the merchant that is external to the infrastructure managed by the transaction processor 8. This may be a cash purchase or a card-based payment purchase conducted across an alternative payment transaction network (for example, Visa as opposed to MasterCard).

Once the sale has been initiated, the merchant 4 connects to the VAT module 16 at step 304 via a suitable facility provided at the merchant. It is envisaged that this facility will be a software application configured to be a counterpart to the functionality provided by the VAT module 16 at the VAT refund manager 15 and therefore forming part of the overall computing environment of the merchant apparatus 4a. Therefore, this facility may form part of a dedicated computing apparatus instead of being incorporated into the POS terminal of the merchant, although this would be possible if the facility was able to be run side-by-side with the POS functionality on the same equipment.

At step 306, it is determined whether the payment transaction is a cash transaction or if a payment card is to be used.

If it is a cash payment, the merchant generates a transaction record at step 308 and enters a customer/cardholder ID which is a unique identifier allocated to the cardholder (in this case paying with a cash transaction) that the cardholder will acquire through the registration process. It should also be noted that during the registration process, the cardholder will submit details of their electronic payment card that they wish to be associated with the VAT refund process. So, even though cash may be used to perform transactions, it is still possible for the user to obtain a VAT refund to an account associated with a nominated electronic payment card.

It is envisaged that the cardholder ID will be supplied by the cardholder at the time the cardholder identifies that they wish to make a claim for a refund of the VAT paid on the transaction. The cardholder ID will be used for identification of the transaction file by the VAT refund agent 12 as will be described later. Alternatively, the cardholder ID may be generated by the merchant dynamically at this point although the cardholder would then be required to register with the VAT refund manager 15 in order to supply the necessary information such as name, address and passport data.

If the transaction is to be a card-based transaction that is performed outside of the infrastructure of the transaction processor 8, the merchant 4 reads the cardholder's card at the merchant POS apparatus 4a at step 310 at which point the transaction is performed. The transaction is conventional and so will not be described in detail here. Then at step 312 a transaction record is generated based on the PAN data extracted from the cardholder's card at step 310.

Once a transaction record has been generated either at step 308 or step 312, the merchant enters into the transaction one or more VAT data pairs at step 314 as described above with reference to process 100 and 200. Once the transaction record has been generated, the process 300 performs an eligibility check on the transaction record at step 316 to determine whether the total amount of the transaction is eligible for a refund of the VAT. The merchant 4 would make this determination by referring to internally stored data listing minimum and/or maximum thresholds for the transaction amount to be eligible for a VAT refund. Suitable checks could also be conducted for the eligibility of the product type for a VAT refund.

If the process is determined as eligible for a VAT refund, the transaction record is communicated to the VAT refund manager 15 at step 318, as indicated as arrow ‘J’ in FIG. 1, where it is stored in the VAT database 20 at step 122 in process 100 as described above. Conversely, if the transaction is determined as ineligible for a VAT refund, the process ends at step 320.

Having described the processes by which transaction data may be collected by the VAT module and by which refund amounts may be calculated, reference will now be made to FIG. 5 which explains an embodiment of a process 400 in which the refund of VAT may be obtained by the cardholder. It will be noted that the process 400 includes interaction between the cardholder 2, the VAT refund manager 15 and the VAT refund agent 12.

The process begins at step 402 at which the user logs on to a VAT refund software application or ‘app’ provided on their computing device 30. It is envisaged that the app will be most effective when provided on a mobile computing device such as a smartphone, although this does not preclude it from being run on a non-mobile device, such as a home computer. As will be explained the app enables the user/cardholder to view a list of transactions that the user has carried out, that have been identified as eligible for a VAT refund and what the VAT refund value will be.

The app is configured to receive frequent data updates from the VAT module 16 of the transaction processor 8 so that the app is able to maintain an up-to-date record of transactions associated with the cardholder. This is illustrated at step 404 at which the app receives a data feed from the VAT database 20 and displays the list of transaction records 124 for viewing by the cardholder. Of course, it will be understood that the app displays a transaction record summary to the user and not the raw transaction record data.

At step 406 the cardholder inputs a selection of one or more of the displayed transaction records for which they wish to make a claim for a refund of the VAT. The selection may be achieved by the way of respective check boxes as would be known to the skilled person. Once the selections are made, the app sends the transaction selection back to the VAT refund manager 15.

Once the VAT refund manager 15 receives the transaction record selections at step 408 it retrieves the selected transaction records and calculates the total refund amount that is due to the cardholder at step 410.

The VAT refund manager 15 is now in a position to generate a VAT refund file at step 412 that will serve to trigger the VAT refund to the cardholder. The VAT refund file will contain suitable information extracted from the relevant transactions to enable a VAT refund to be provided to the cardholder. For example the VAT refund file may include data items such as: credit card number (PAN), VAT refund amount, and, optionally, cardholder ID and merchant ID.

At step 414, the VAT refund manager 15 sends the generated VAT refund file to the VAT refund agent 12 and then, at step 416 the generated VAT refund file is sent to the cardholder app on the mobile device 30. The VAT refund manager 15 sends the VAT refund file to both the VAT refund agent 12 and also to the cardholder so that the VAT refund agent 12 is able to reconcile the VAT refund file it receives with the hard-copy version that will be sent to it by the cardholder at a later date, duly stamped and authorised by the customs authority. This will enable the VAT refund agent to finalise the VAT refund file and trigger a refund to the cardholder, as will now be explained.

So, at step 418, the VAT refund agent 12 receives the VAT refund file electronically from the VAT refund manager 15. The VAT refund file is therefore stored by the VAT refund agent 12 until such time as it receives the counterpart VAT refund form from the cardholder. At step 420, the cardholder app receives the VAT refund file from the VAT refund manager 15. At this point, the cardholder is able to command the cardholder app to generate a VAT refund form from the VAT refund file and print the VAT refund form into a hard-copy format, at step 422, through a suitable printing device. This form generation and printing process transfers all of the necessary data from the VAT refund file into the VAT refund form in a format that will be acceptable by the customs authority and the VAT refund agent 12. It should be appreciated that although it is envisaged that the VAT refund form will need to be printed into a hard copy format, it is possible that the VAT refund form could be provided as an e-document that can be viewed on a suitable computing device such as a smartphone or a tablet computer. The facility would be provided for the customs service to electronically ‘stamp’ or authorise the form, and then the e-document could be transmitted electronically to the VAT refund agent 12.

Once the cardholder has printed the VAT refund form, the form must be presented to the customs authority at the port of exit so that the purchased goods can be expected and so that the VAT refund form may be stamped. Once these requirements have been satisfied, the cardholder posts the stamped VAT refund form to the VAT refund agent 12 or, alternatively, deposits the stamped VAT refund form at a suitable deposit box affiliated with the VAT refund agent 12 located at the port of exit.

At step 418, once the VAT refund agent 12 receives the hard copy VAT refund form the cardholder, the VAT refund agent 12 retrieves the stored VAT refund file from storage and reconciles it with the stamped VAT refund form, thereby authorising the refund. Once this has been validly performed, it triggers a refunding event at step 424 to pay the cardholder the refund value that is identified in the VAT refund file. At the refund event step 424, the VAT refund agent 12 updates the VAT refund file to flag that a refund payment to the cardholder may now be made. At this point, the VAT refund agent transmits a copy of the VAT refund file to the tax authority 11 (shown by arrow K) and, in response, receives an account credit for the VAT refund amount (shown by arrow K′). Once the VAT refund agent 12 has received the funds from the tax authority, then it credits an intermediary payment account 40 as may be provided through a suitable payment gateway provider such as DataCash®, as is shown by arrow L. Note that the system may be configured so that the tax authority 11 credits the intermediary account 40 directly, as shown by the dotted arrow connecting arrows K′ and L.

At step 426 the VAT refund agent 12 sends the updated VAT refund file to the VAT refund manager 15 which receives the file at step 428 and then proceeds to process the refund to the cardholder at step 430. In this embodiment, refunding the cardholder at step 430 involves the VAT refund manager 15 triggering payment (arrow M) from the intermediary account 40 to the issuer 10 associated with the cardholder thereby generating a credit event by the issuer so that the cardholder's account is credited with an amount equal to the refund value. This is shown by arrow H in FIG. 1.

In an alternative embodiment, payment in respect of the VAT refunds may be made to the intermediary account 40 by the tax refund agent 12 in advance of it receiving payment from the tax authority 11. This will reduce the timescale for refunding the cardholder and so is beneficial from the perspective of the cardholder.

In a further alternative embodiment, it is envisaged that the VAT refund agent 12 may itself trigger the payment to the cardholder rather than this step being handled by the VAT refund manager 15.

In the above embodiment, the payment to the cardholder's account at the issuer 10 is made in response to the availability of funds from the tax authority 11. So, the intermediary account 40 must be in funds before the VAT refund manager 15 is able to make payment to the issuer 10. It is envisaged that the tax authority 11 would place the intermediary account 40 in funds directly to cover VAT refund files submitted to it but, alternatively, it could be configured to fund the intermediary account periodically to cover a predetermined number of days of expected VAT refunds.

The electronic processing and management of tax refunds according to the invention offers many benefits. Importantly, the process enables the cardholder 2, more specifically the cardholder's account as provided by the issuer, to be credited with funds equal to the tax paid on overseas purchases with only minor input by the cardholder 2 at the port of exit of the country. To achieve this, the established business infrastructure of the transaction processor 8 is used to provide a more efficient system to coordinate and fulfil tax refunds for cardholders that are a member of its network.

Compared to existing systems, where the cardholder 2 must complete hard-copies of the appropriate forms to record the purchases and then present these forms for inspection at customs, the invention provides a more transparent process for the cardholder which encourages take up by consumers when travelling. What is more, the cardholder receives the tax refund swiftly, typically within one or two billing cycles, which is faster than is currently the case with paper-based methods with or without using a tax refund agency.

Furthermore, since the tax refund scheme operates through an existing cooperative network of card-issuing banks, acquirers, merchants and payment processors there is increased assurance over the identity of the cardholder who is making the tax refund claim and control over the use of the card. As such, where a card is used to purchase goods under the scheme and then is used subsequently to claim a refund of the purchase tax, there is established traceability of the individual using the card. This traceability acts as a significant deterrent to fraudulent claims from consumers and provides greater traceability and transparency than the paper-based schemes which, typically, only require passport details as the form of identification. The flow of refund transactions through the VAT refund manager 15 also enables suitable risk-based analytics to be provided to the customs service which can be used to determine a risk score which the customs service can use as an additional factor in the approval of the VAT refund procedure.

A significant advantage of the ‘automated’ tax refund scheme described herein is that the merchant is required to perform less administrative work compared with the current paper-based system since there is a reduction in paperwork that needs to be completed at the point of sale; the VAT refund manager 15 analyzes which transactions are eligible in parallel to the clearing process. Not only is this an operational burden for the merchant but it is usually considered difficult for the merchant to implement the process in a way that complies fully with the requirements of the tax authority. The ‘automated’ scheme as described above would remove the need for the merchant to create manual document and would simply require the merchant to register with the scheme.

Since the administrative burden on merchants is reduced, it is envisaged that the numbers of merchants willing to participate in the tax refund scheme will increase, as will the geographical distribution of the network of merchants. These factors will likely encourage retail shopping by international consumers. In turn, this is likely to lead to a wider range of goods that are eligible for vat refunds and may increase market competition for those goods that will benefit the consumer.

It is envisaged that the electronic tax refund process may operate in parallel with an established ‘paper-based’ equivalent scheme pending increased take up of the electronic scheme to a stage that there is justification for disbanding the paper-based counterpart.

Some variants to the specific embodiments described above have already been explained. However, the skilled person will appreciate that other modifications may be made to the specific embodiments without departing from the invention, as defined by the claims

In the above embodiments, it is described that the payment transaction is initiated through the use of an electronic payment card, for example a chip and pin card that is known to the skilled person. However, although the description is set in the context of using physical payment cards, it will be appreciated that this is not necessarily the case and the payment card may also be a non-physical card. For example, the non-physical card may take the form of a payment card that has been ‘digitized’ or ‘on-boarded’ onto a mobile wallet device, or it may be a ‘virtual’ payment card having a virtual card number.

The ‘VAT app’ described above that is implemented on the cardholder's mobile electronic device 30 performs the main role of interfacing with the cardholder to display the potential VAT refund associated with each transaction. However, it will be appreciated that the VAT app may be provided with further features to enhance the cardholder's shopping experience. For example, the VAT app could be configured to display to the cardholder eligible merchant in their vicinity using GPS data and knowledge of the location of the merchant's as obtained from the knowledge base 30.

In the above embodiments, it has been described that the VAT refund agent 12 makes the decision to authorise the VAT refund at the point the VAT refund form sent by the cardholder is reconciled with the VAT refund file that was generated by the VAT refund manager 15 and stored at the VAT refund agent 12. However, it is envisaged that appropriate rules may be developed and implemented by the VAT refund manager 15 that would allow it to make the authorization determination instead of the VAT refund agent 12. These rules may be developed by the VAT refund manager 15 through cooperation with the tax authority 11 and would permit the VAT refund manager a degree of autonomy and trust to make such an authorization.

What is claimed is:

1. A method for processing a transaction relating to a purchase and refunding a tax paid on the purchase, the method comprising:
receiving, over a network from a merchant apparatus, payment transaction data relating to a payment transaction associated with an electronic payment card,
analyzing the payment transaction data to determine whether the payment transaction is eligible for a tax refund,
determining a tax refund value corresponding to the payment transaction,
determining that the payment transaction is authorised for a tax refund, and
coordinating with at least an issuer associated with the electronic payment card in order to credit an account associated with the electronic payment card with the tax refund value.

2. The method of claim 1, wherein receiving payment transaction data includes receiving one or more clearing files each of which relates to a group of one or more clearing records, wherein each clearing record corresponds to an associated payment transaction.

3. The method of claim 1, wherein analyzing the payment transaction data includes verifying that the payment transaction is a cross-border payment transaction.

4. The method of claim 3, wherein verifying that the payment transaction is a cross-border payment transaction includes comparing the country in which the merchant is based with the country in which the issuer is based.

5. The method of claim 4, wherein verifying that the payment transaction is cross-border includes comparing a merchant ID data field and a Bank Identification Number (BIN) data field.

6. The method of claim 3, wherein analyzing the payment transaction data further includes verifying that the amount of the payment transaction meets a predetermined minimum limit threshold, or a maximum limit threshold, or a maximum and minimum limit threshold.

7. The method of claim 3, wherein analyzing the payment transaction data further includes verifying that a merchant ID data field corresponding to the merchant apparatus is a registered participant.

8. The method of claim 1, wherein determining the tax refund value includes applying a predetermined refund factor to a sales value item of the transaction.

9. The method of claim 8, wherein the predetermined refund factor is selected from a set of different refund factors each of which corresponds to a respective value range.

10. The method of claim 1, wherein determining that the payment transaction is authorised for a tax refund includes receiving an authorization for the refund from a tax refund agent.

11. The method of claim 10, wherein prior to receiving the authorization from the tax refund agent, generating a transaction record from the payment transaction data and communicating the transaction record to a computing device associated with the electronic payment card for displaying to a cardholder.

12. The method of claim 11, further including receiving a selection of one or more transaction records from the computing device for which a tax refund is requested.

13. The method of claim 12, further including collating the selection of one or more transaction records from the computing device and generating a tax refund file including the one or more transaction records.

14. The method of claim 13, further including transmitting the generated tax refund file to the tax refund agent for authorization.

15. The method of claim 1, wherein coordinating with at least an issuer associated with the electronic payment card in order to credit an account associated with the electronic payment card with the tax refund value includes triggering a payment to the issuer through an intermediary account.

16. The method of claim 15, wherein the intermediary account is credited directly or indirectly by a tax authority.

17. A system for processing a payment transaction relating to a purchase and refunding a tax paid on the purchase, the system comprising:
a merchant apparatus for generating a payment transaction relating to a purchase and to transmit the transaction over a network, and
a transaction processor configured to receive payment transaction data relating to the payment transaction transmitted to it over the network, wherein the transaction processor is configured to:
analyze the payment transaction data to determine whether the payment transaction is eligible for a tax refund,
determine a tax refund value corresponding to the payment transaction,
determine that the payment transaction is authorised for tax refund, and
coordinate with at least an issuer associated with the electronic payment card in order to credit an account associated with the electronic payment card with the tax refund value.

18. The system of claim 17, wherein the transaction processor is configured to receive one or more clearing files each of which relates to a group of one or more clearing records, wherein each clearing record corresponds to an associated payment transaction.

19. The system of claim 17, wherein the transaction processor is configured to analyze the payment transaction data to verify that the payment transaction is a cross-border payment transaction.

20. The system of claim 19, wherein, in analyzing the payment transaction data, the transaction processor is further configured to verify that the amount of the payment transaction meets a predetermined minimum limit threshold, or a maximum limit threshold, or a maximum and minimum limit threshold.

21. The system of claim 19, wherein, in analyzing the payment transaction data, the transaction processor is further configured to verify that a merchant ID data field corresponding to the merchant apparatus is a registered participant.

22. The system of claim 17, wherein, in determining the tax refund value, the transaction processor is further configured to apply a predetermined refund factor to a sales value item of the transaction.

23. The system of claim 17, wherein, in determining that the payment transaction is authorised for a tax refund, the transaction processor is configured to receive an authorization for the refund from a tax refund agent.

24. The system of claim 23, wherein prior to receiving the authorization, the transaction processor is configured to generate a transaction record from the payment transaction data and to transmit the transaction record to a computing device associated with the electronic payment card for displaying to the cardholder.

25. The system of claim 24, wherein the transaction processor is further configured to receive a selection of one or more transaction records from the computing device for which a tax refund is requested.

26. The system of claim 25, wherein the transaction processor is further configured to collate the selection of one or more transaction records from the computing device and generate a tax refund file including the one or more transaction records.

27. The system of claim 26, wherein the transaction processor is configured to transmit the generated tax refund file to the tax refund agent for authorization.

28. The system of claim 17, wherein, in coordinating with at least an issuer associated with the electronic payment card in order to credit an account associated with the electronic payment card with the tax refund value, the transaction processor is configured to trigger a payment to the issuer through an intermediary account.

29. A computing platform configured to process payment transactions relating to electronic payment cards conducted over a network, wherein the computing platform is further configured to:
receive payment transaction data relating to a payment transaction associated with an electronic payment card,
analyze the payment transaction data to determine whether the payment transaction is eligible for a tax refund,
determine a tax refund value corresponding to the payment transaction,
determine that the payment transaction is authorised for a tax refund, and
coordinate with at least an issuer associated with the electronic payment card in order to credit an account associated with the electronic payment card with the tax refund value.
